(19) United States
(12) Patent Application Publication
(10) Pub. No.: US 2012/0136759 A1
(43) Pub. Date: May 31, 2012

(54) AUTOMATIC INVENTORY BALANCING

(75) Inventors: Thomas K. Roslak, Northport, NY (US); Matthew J. Eschbach, Kirkland, WA (US); Ritesh Gupta, Lake Romkonkoma, NY (US)

(73) Assignee: SYMBOL TECHNOLOGIES, INC., Schaumburg, IL (US)

(21) Appl. No.: 12/957,173

(22) Filed: Nov. 30, 2010

(51) Int. Cl. G06Q 10/00

(52) U.S. Cl. 705/28

(57) ABSTRACT

A method and system for automatic inventory balancing includes a scanning device 100 operable to read an item identifier. An inventory module 102 provides information including the item identifier with an indication that the item is being added or removed form stock. An inventory database controller 104 receives the information and changes a tally in the database indicating that the item has been added or removed from stock, in accordance with the information. A display 112 that displays the tally of the items to a user.

### FIELD OF THE DISCLOSURE

The present invention relates generally to monitoring inventory, and more particularly to automatic inventory balancing.

### BACKGROUND

Small retailers have difficulty with inventory control, inasmuch as they can not afford to hire personnel specifically for inventory control. These retailers spend most of their time running their operation, serving customers, and doing ordinary paperwork. Larger retail establishments have a definitive competitive advantage over these small companies by having the ability to hire inventory control personnel or even to purchase inventory control software to provide information about product offerings, inventory, and pricing levels in real time.

Small retailers can not afford these same resources, and the vast majority of these companies do not have professional or minimal computer support. Moreover, the existing inventory control software and hardware companies have a relatively large start up cost for hardware and to set up their system. This includes putting in data from traditional paper and pencil systems into the computer system, which is a large cost disadvantage. Further, even if a small retailer had an inventory control system, these retailers still find difficulty competing with large retailer, particularly when it comes to web presence on the Internet.

Accordingly, there is a need for a technique to provide automatic inventory balancing for small retailers.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system, in accordance with the present invention.

FIG. 2 is a flowchart of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a technique to provide automatic inventory balancing for small retailers. The present invention uses this technique to also provide a competitive web presence through the utilization of an automated inventory management web service. This web service could also be used to automatically replenish decremented inventory. The present invention can be used to populate an inventory control system. In particular, the present invention only inventories future transactions (i.e. a sale of old stock or the entry of new stock), and does not inventory any stock that is already on the premises. As old stock is replaced with new stock, the inventory would become more accurate as time progresses, with minimal effort by the user. The user need only scan items that are sold, and new stock that is arriving.

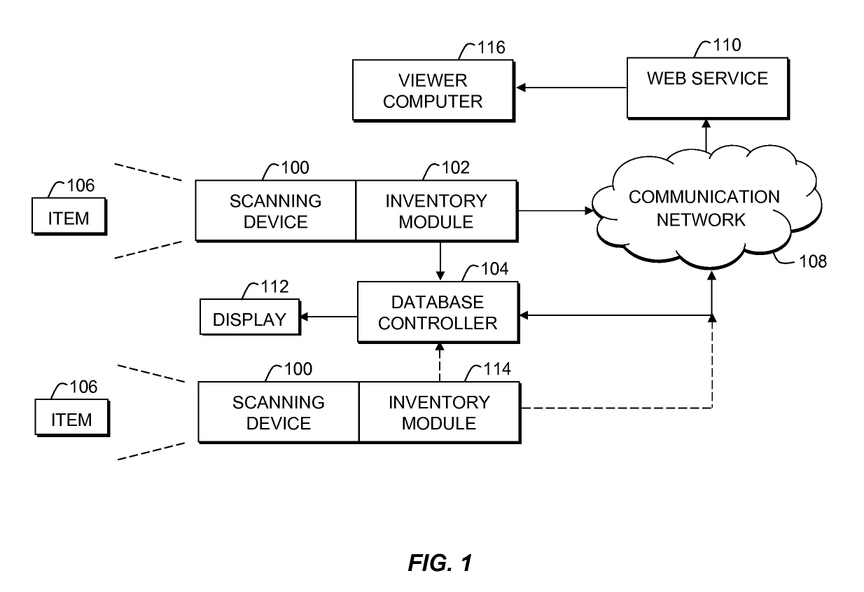

FIG. 1 shows an apparatus adapted to support the inventive concepts of the embodiments of the present invention. Those skilled in the art will recognize that these figures do not depict all of the equipment necessary for the devices to communicate but only those components particularly relevant to the description of embodiments herein. For example, the device 100, module 102, and inventory database controller 104 can include power supplies, separate processors, controllers, memories, interfaces, buffers, and the like, which are well-known. In addition, processing and controlling units are known to comprise basic components such as, but not limited to, microprocessors, microcontrollers, memory cache, application-specific integrated circuits (ASICs), and/or logic circuitry. Further, a user interface or programmer can be used to program the device and module through a wired or wirelessly connection, using techniques known in the art.

Those skilled in the art are aware of the many design and development techniques available to configure the operation of a scanning device, 100 and inventory database controller 104. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. Therefore, although the scanning device 100 and inventory module 102 are shown as separate entities, the present invention envisions that these two components could be incorporated into one entity.

Referring back to FIG. 1, a system is shown for automatic inventory balancing, in accordance with the present invention. A scanning device 100 is operable to scan an item 106 of stock in an establishment, such as a retail store for example. The item 106 includes some type of identifier, such as any one of; a barcode printed on the item, an Electronic Article Surveillance (EAS) tag affixed to the item, a Radio Frequency Identification (RFID) tag embedded in the item, and the like. The scanning device 100 serves to read the identifier of the item 106.

An inventory module 102 is coupled to (or incorporated within) the scanning device 100. The coupling could be a wired or wireless connection, using techniques that are known in the art. It is envisioned that the module 102 could have two functions—monitoring the scanning of a new item 106 that will be stocked in the establishment, or monitoring the scanning of an existing item in stock that is being removed (sold) from the establishment. This could be accomplished by providing a simple switch on the inventory module 102, or even the scanning device 100, where a user could flip the switch to provide an indication to the database controller 104 as to whether the item 106 is being added or removed from stock.

Alternatively, different inventory modules can be coupled to the scanning device—one module for incoming stock, and one module for outgoing stock. For example, an outgoing inventory module 114 can be connected to a scanning device at a checkout kiosk, where information from the outgoing inventory module will always indicate to a local inventory database controller a decrement in stock of the identified item. Similarly, an incoming inventory module 102 can be connected to another scanning device at a loading dock, where information from the incoming inventory module will always indicate to the local inventory database controller an increment in stock of the identified item.

In one embodiment, the inventory module 102 is a communication device that only reads the identifier of what is scanned without any intelligence, and sends this information, including whether the item is being added or removed from stock, to the local inventory database controller 104. The local inventory database controller can then receive this information and derive what the item is from the identifier (using a stored table associating items with their identifiers), and simply change a tally in an inventory database indicating that the item has been added or removed from stock, in accordance with the information. This tally of items can be displayed to the business owner on a display 112 associated with the local inventory database controller 104, for example. It will be recognized that, at first, the inventory database will include an incorrect tally of items stocked in the establishment, since old items that are already in stock will not be considered. As a result, the tally for an item will never be greater than the total of the existing and new stock at hand. However, as old stock is depleted, and new stock is added, the inventory control system of the present invention will cause the tally of items in the database to automatically approach a more accurate inventory result. This occurs with very little effort on the part of the business owner, and ensures that the business owner has at least the amount of stock indicated.

In a further embodiment, the inventory module 102 (or local inventory database controller 104) could provide information about items added to stock at that establishment, and optionally items removed from stock, to an automated inventory management web service 110 through a wired or wireless communication network 108, such as the Internet. The information could also include the sale price for each item. The web service 110 or local inventory database controller 104 could store and tabulate the change in stock of an item at that establishment, and display these tabulations (and optionally the sales prices) to viewers on their computer displays 116. The web service 110 could also order stock to automatically replenish any decremented inventory. Even though the absolute amount of stock of an item at an establishment may be inaccurate, viewers using the web service are assured that there is at least that amount of stock for a desired item for sale at any particular establishment. In this way, any establishment will have an even competition with any other establishment for the sale of a particular item without having the problem of an establishment being out of stock of the item.

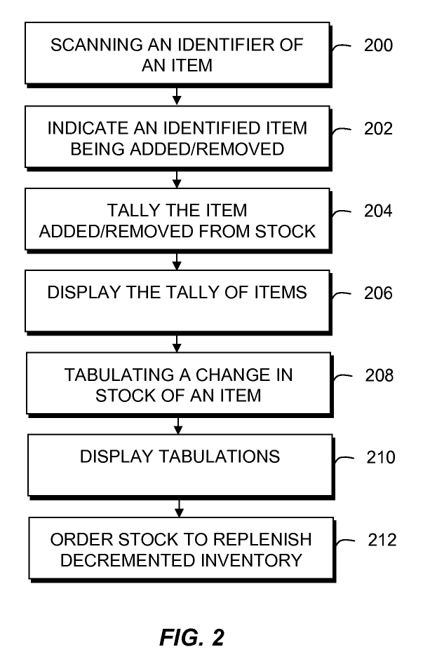

FIG. 2 shows a method for automatic inventory balancing, the method including a step of scanning 200 an identifier of an item.

A next step includes providing 202 information including the identifier of the item along with an indication that the item is being added or removed form stock, by at least one inventory module. In one embodiment, there is only one inventory module that has a switch to provide an indication as to whether the item is being added or removed from stock. In another embodiment, there are two inventory modules, where one module is used to provide an indication for incoming stock and the other module is used to provide an indication for outgoing stock. The two modules could be used with separate scanning devices, or could be detached and connection to one scanning device.

A next step includes tallying 204 an addition or removal of an item from stock, in accordance with the information. Since only present stock is monitored, the tally for an item will not be greater than the total of the existing and new stock at hand. The tally of items in the database approaches a more accurate inventory result as old stock is depleted and new stock is added.

A next step includes displaying 206 the tally of the items to a user on a display screen of a local computer or database controller.

A further embodiment of the present invention includes tabulating 208 a change in stock of an item at an establishment using the information, and displaying 210 these tabulations on a computer display. The costs for particular items can also be displayed along with the tabulations. This embodiment can also include ordering stock (212) to automatically replenish any decremented inventory.

Advantageously, the present invention provides a good solution for a small retailer to obtain automatic inventory balancing, without the cost or learning needed for a commercial inventory control system.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized controllers of processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for automatic inventory balancing, the system comprising:
a scanning device operable to read an identifier of an item;
at least one inventory module coupled to the scanning device, the at least one inventory module operable to provide information including the identifier of the item along with an indication that the item is being added or removed form stock;
an inventory database controller coupled to the at least one inventory module, the controller operable to receive the information from the at least one inventory module, and change a tally in the database indicating that the item has been added or removed from stock, in accordance with the information; and
a display associated with the local inventory database controller, wherein the controller directs the display to display the tally of the items to a user.

2. The display of claim 1, wherein the inventory module includes a switch to provide an indication to the database controller as to whether the item is being added or removed from stock.

3. The system of claim 1, further comprising a second inventory module, wherein one module is used to provide an indication for incoming stock, and the other module is used to provide an indication for outgoing stock.

4. The system of claim 1, wherein the tally for an item is not greater than the total of the existing and new stock at hand.

5. The system of claim 1, wherein the tally of items in the database approaches a more accurate inventory result as old stock is depleted and new stock is added.

6. The system of claim 1, further comprising an automated inventory management web service that is operable to tabulate a change in stock of an item at an establishment using the information, and display these tabulations to viewers on their computer displays.

7. The system of claim 8, wherein the web service is also operable to order stock to automatically replenish any decremented inventory.

8. A method for automatic inventory balancing, the method comprising:
scanning an identifier of an item;
providing information including the identifier of the item along with an indication that the item is being added or removed form stock, by at least one inventory module;
tallying an addition or removal of an item from stock, in accordance with the information; and
displaying the tally of the items to a user.

9. The method of claim 8, wherein providing includes the at least one inventory module having a switch to provide an indication as to whether the item is being added or removed from stock.

10. The method of claim 8, wherein providing includes two inventory modules, wherein one module is used to provide an indication for incoming stock and the other module is used to provide an indication for outgoing stock.

11. The method of claim 8, wherein in the tallying step, the tally for an item is not greater than the total of the existing and new stock at hand.

12. The method of claim 8, wherein in the tallying step, the tally of items in the database approaches a more accurate inventory result as old stock is depleted and new stock is added.

13. The method of claim 8, further comprising:
tabulating a change in stock of an item at an establishment using the information, and
displaying these tabulations on a computer display.

14. The method of claim 13, further comprising ordering stock to automatically replenish any decremented inventory.
